(19) United States
(12) Patent Application Publication
(10) Pub. No.: US 2023/0162477 A1
(43) Pub. Date: May 25, 2023

(54) METHOD FOR TRAINING MODEL BASED ON KNOWLEDGE DISTILLATION, AND ELECTRONIC DEVICE

(71) Applicant: BEIJING BAIDU NETCOM SCIENCE TECHNOLOGY CO., LTD., Beijing (CN)

(72) Inventor: Jianwei LI, Beijing (CN)

(21) Appl. No.: 18/151,639

(22) Filed: Jan. 9, 2023

Related U.S. Application Data
(63) Continuation of application No. PCT/CN2022/083065, filed on Mar. 25, 2022.

(30) Foreign Application Priority Data
Sep. 29, 2021 (CN) 202111155110.1

(51) Int. Cl. G06V 10/764; G06V 10/72

(52) U.S. Cl. CPC G06V 10/764; G06V 10/72

(57) ABSTRACT

A method for training a model based on knowledge distillation includes: inputting feature vectors obtained based on trained sample images into a first coding layer and a second coding layer, in which the first coding layer belongs to a first model, and the second coding layer belongs to a second model; obtaining first feature vectors by aggregating output results of the first coding layer; determining second feature vectors based on outputs of the second coding layer; and updating the first feature vectors by performing a distillation on the first feature vectors and the second feature vectors.

### CROSS-REFERENCE TO RELATED APPLICATIONS

This application is a continuation of International Application No. PCT/CN2022/083065, filed on Mar. 25, 2022, which claims priority to Chinese Patent Application No. 202111155110.1, filed on Sep. 29, 2021. The entire disclosures of the above-identified applications are incorporated herein by reference.

### TECHNICAL FIELD

The disclosure relates to the field of computer technologies, especially the field of artificial intelligence (AI) technologies such as computer vision (CV) and natural language processing (NLP), in particular to a method for training a model based on knowledge distillation, an electronic device, and a storage medium.

### BACKGROUND

With the development of information technologies, neural network models are widely used in machine learning tasks such as CV, information retrieval, and information recognition. However, to achieve better learning results, the neural network models often have a huge number of parameters which generally requires huge calculation examples for inference and deployment, that is, a large amount of computing resources are used during the training and inference phases, thus such large neural network models may not be deployed on resource-limited devices. That is, to ensure excellent performance, the large neural network models often have high requirements on the deployment environment due to the size of the model and the large amount of data, which greatly limits the usage scope of such models.

### SUMMARY

According to an aspect of the disclosure, a method for training a model based on knowledge distillation is provided. The method includes: inputting feature vectors obtained based on trained sample images into a first coding layer and a second coding layer, in which the first coding layer belongs to a first model, and the second coding layer belongs to a second model; obtaining first feature vectors by aggregating output results of the first coding layer; determining second feature vectors based on outputs of the second coding layer; updating the first feature vectors by performing a distillation on the first feature vectors and the second feature vectors; and completing training of the first model by classifying the first feature vectors that are updated.

According to another aspect of the disclosure, a method for recognizing an image is provided. The method includes: inputting an image to be recognized into a trained recognition model, in which the trained recognition model is trained according to the method for training a model based on knowledge distillation; and recognizing the image to be recognized by the trained recognition model.

According to another aspect of the disclosure, an electronic device is provided. The electronic device includes: at least one processor and a memory communicatively coupled to the at least one processor. The memory stores instructions executable by the at least one processor, and when the instructions are executed by the at least one processor, the at least one processor is enabled to implement the method according to any one of embodiments of the disclosure.

According to another aspect of the disclosure, a non-transitory computer-readable storage medium storing computer instructions is provided. The computer instructions are configured to cause a computer to implement the method according to any one of embodiments of the disclosure.

It should be understood that the content described in this section is not intended to identify key or important features of embodiments of the disclosure, nor is it intended to limit the scope of the disclosure. Additional features of the disclosure will be easily understood based on the following description.

### BRIEF DESCRIPTION OF THE DRAWINGS

Unless stated otherwise, the same reference numbers in the drawings refer to the same or like parts or elements. The drawings are not necessarily to scale. It should be understood that these drawings depict only some embodiments of the disclosure and should not be considered as limiting the scope of the disclosure.

FIG. 1 is a flowchart of a method for training a model based on knowledge distillation according to an embodiment of the disclosure.

FIG. 2 is a flowchart of a method for training a model based on knowledge distillation according to another embodiment of the disclosure.

FIG. 3 is a schematic diagram of a Transformer model in the field of CV according to an embodiment of the disclosure.

FIG. 4 is a schematic diagram of model distillation according to an embodiment of the disclosure.

FIG. 5 is a schematic diagram of model distillation according to another embodiment of the disclosure.

FIG. 6 is a flowchart of a method for recognizing an image according to an embodiment of the disclosure.

FIG. 7 is a schematic diagram of an apparatus for training a model based on knowledge distillation according to an embodiment of the disclosure.

FIG. 8 is a schematic diagram of a classifying module according to an embodiment of the disclosure.

FIG. 9 is a schematic diagram of an apparatus for recognizing an image according to an embodiment of the disclosure.

FIG. 10 is a block diagram of an electronic device used to implement a method for training a model based on knowledge distillation or a method for recognizing an image according to an embodiment of the disclosure.

### DETAILED DESCRIPTION

The following describes embodiments of the disclosure with reference to the accompanying drawings, which includes various details of the embodiments of the disclosure to facilitate understanding, and shall be considered merely exemplary. Therefore, those skilled in the art should recognize that various changes and modifications can be made to the embodiments described herein without departing from the scope and spirit of the disclosure. For clarity and conciseness, descriptions of well-known functions and structures are omitted in the following description.

In the related art, the Transformer model is a new type of artificial intelligence model developed by a famous Internet company. Recently, this model has been frequently used in the CV field with proved excellent effects. However, compared with other models (such as convolutional neural network models), the Transformer model has many parameters that generally require huge calculation examples for inference and deployment, that is, a lot of computing resources are used in the training and inference phases, thus such large neural network models may not be deployed on resource-limited devices.

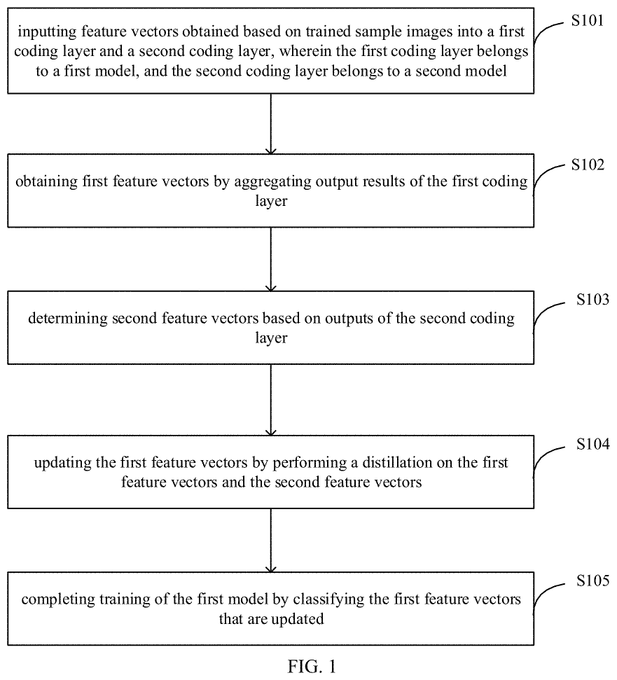

According to embodiments of the disclosure, a method for training a model based on knowledge distillation is provided. FIG. 1 is a flowchart of a method for training a model based on knowledge distillation according to an embodiment of the disclosure. The method includes the following.

At block S101, feature vectors obtained based on trained sample images are input into a first coding layer and a second coding layer, in which the first coding layer belongs to a first model, and the second coding layer belongs to a second model.

In an example, the second model to which the second coding layer belongs is an original model or a trained model, and the first model to which the first coding layer belongs is a new model or a new model to be generated based on the trained model. In detail, the first model may be a student model, and the second model may be a teacher model.

In an example, the first coding layer and the second coding layer are corresponding layers in different models. For example, the first coding layer is the third layer in the model to which it belongs, and the second coding layer is the layer corresponding to the first coding layer in the model to which it belongs, for example, it can also be the third layer.

In an example, although theoretically any layer in the first model can be selected as the first coding layer, the last layer of the model does not substantially reduce the amount of calculation after the distillation, it is not recommended to determine the last layer as the first coding layer. Generally, any coding layer that is not the last layer in the model is selected as the first coding layer.

In an example, the image sample may be a graphic image. In detail, multiple pictures of equal size are converted into multiple feature vectors of the same dimensions, in which the number of pictures is equal to the number of generated feature vectors. For example, an image to be input into the model is divided into patches of equal size, the size of each image patch needs to be equal, and the image content in the patches can overlap. After image preprocessing and feature vector conversion, the feature vectors of the same dimensions are generated, and each patch corresponds to one feature vector. The plurality of feature vectors generated based on the image patches are input into the first coding layer and the second coding layer in parallel. As mentioned above, the distillation can be used to perform compression and distillation on the Transformer model in the CV field. The image to be recognized is divided into multiple patches, and the image content in each patch may be classified in detail. The image patches are input in parallel, so that the overall efficiency is increased through parallel processing. The image patches may overlap, thus the possibility of missing some features due to dividing may be reduced.

At block S102, first feature vectors are obtained by aggregating output results of the first coding layer.

In an example, the number of feature vectors input by the first coding layer is equal to the number of feature vectors output by the first coding layer. The aggregating process is to extract features from the feature vectors output by the first coding layer and reduce the number of feature vectors, which is also known as pruning. For example, the first coding layer outputs 9 feature vectors, and 5 feature vectors are obtained after aggregating. In detail, the aggregating operation may be convolution operation. Convolution can efficiently filter out useful features from the feature vectors, and provide efficient concentration effect.

At block S103, second feature vectors are determined based on outputs of the second coding layer.

In an example, the second feature vectors can be obtained by re-ranking the feature vectors output by the second coding layer according to importance, or by performing feature enhancement processes and then re-ranking the processed feature vectors according to importance.

At block S104, the first feature vectors are updated by performing a distillation on the first feature vectors and the second feature vectors.

In an example, since the first feature vectors are aggregated at least once, the number of first feature vectors is less than the number of the second feature vectors, that is, the size of the first feature vectors is less than the size of the second feature vectors. At this time, feature vectors of equal size to the first feature vector needs to be extracted from the second feature vectors for subsequent distillation, that is, the top-ranked feature vectors or the bottom-ranked feature vectors may be extracted from the second feature vectors that are ranked, which is not limited. However, the size of the extracted feature vectors needs be equal to the size of the first feature vectors. After distillation, the first feature vectors that are updated are obtained, and the first feature vectors that are updated learn some features of the feature vectors corresponding to the second model. This distillation process can be referred to as aggregating distillation or pruning distillation. By extracting the top-ranked feature vectors, the first model can learn certain features of the second model firstly, and these features can be flexibly specified by the ranking rules. For example, after ranking according to importance, the top-ranked feature vectors are extracted, that is, the important feature vectors in the trained model are extracted for the learning of the model under training, which greatly improves the efficiency of model distillation learning.

In an example, different coding layers can be selected as the first coding layers in the same model to perform pruning distillation for multiple times.

At block S105, training of the first model is completed by classifying the first feature vectors that are updated.

The updated first feature vectors are input into the next coding layer. After obtaining the outputs from the last coding layer, the outputs of the last coding layer are classified, so that the training of the first model is completed.

According to the above embodiments, any layer can be selected for pruning or ranking the feature vectors output by the corresponding layer during training, and then the pruned feature vectors and the ranked feature vectors are aligned for knowledge distillation. The disclosure provides a compressed knowledge distillation solution for model compression and distillation training. The above pruning and distillation technical solution can be flexibly used in any layer of the model, and the amount of computation of the trained model is significantly reduced and the compression effect is good, so that the trained model can be deployed to the devices with limited computational capability.

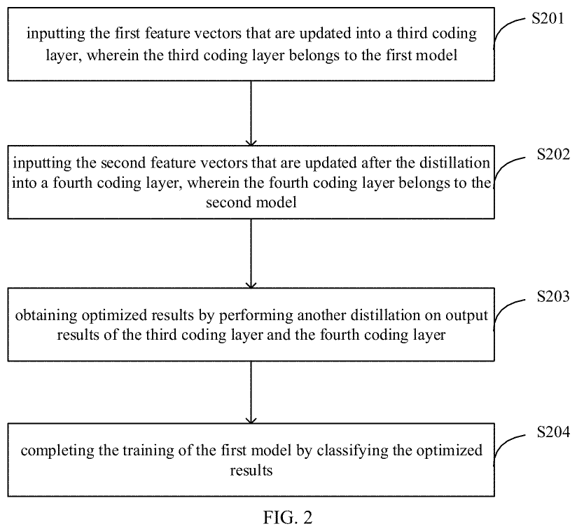

Embodiments of the disclosure provide another method for training a model based on knowledge distillation. FIG. 2 is a flowchart of a method for training a model based on knowledge distillation according to another embodiment of the disclosure. The method includes the following.

At block S201, the first feature vectors that are updated are input into a third coding layer, in which the third coding layer belongs to the first model.

In an example, after at least one distillation process, the first feature vectors that are updated are input into the third coding layer again. The third coding layer and the first coding layer belong to the same model.

At block S202, the second feature vectors that are updated after the distillation are input into a fourth coding layer, in which the fourth coding layer belongs to the second model.

In an example, after at least one distillation process, the second feature vectors that are updated are input into the fourth coding layer again. The fourth coding layer and the second coding layer belong to the same model.

At block S203, optimized results are obtained by performing another distillation on output results of the third coding layer and the fourth coding layer.

In an example, the output results of the third coding layer and the fourth coding layer are distilled again. Since the inputs of the third coding layer are feature vectors that are aggregated, the number of feature vectors output by the third coding layer is smaller than the number of feature vectors output by the fourth coding layer. The same number of feature vectors as the number of feature vectors output by the third coding layer are selected based on a preset condition from the outputs of the fourth coding layer, and subjected to the distillation process with the number of feature vectors output by the third coding layer. The preset condition may be to select the feature vectors ranked first according to importance, or it may be other ranking methods, which is not limited. After the re-distillation, the optimized results are obtained. This distillation method is called direct distillation. In an example, the feature vectors in the model can be directly distilled for multiple times.

At block S204, the training of the first model is completed by classifying the optimized results.

In an example, classifying the optimized results may be, after obtaining the outputs of the last coding layer, classifying the outputs of the last coding layer, to complete the training of the first model.

In the above example, based on pruning distillation, the coding layer that is not subjected to pruning distillation can be selected for direct distillation. Since the distillation process is actually a process in which two models learn from each other, the above-mentioned direct distillation method is used in combination with the pruning distillation can better make the trained model infinitely close to the initial model, and can make the first model close to the second model faster and better, thereby improving the efficiency of the training process.

According to some embodiments of the disclosure, the method includes: obtaining classification results according to feature vectors obtained by a last coding layer of the first model; and in response to that a distillation loss value in distillation is less than a fixed threshold value, obtaining a classification accuracy rate based on the classification results.

In an example, after passing through all the coding layers, the optimized feature vectors output by the first model at last are input into a classifier, and classification results are obtained. The classification results are classification results of the image samples (hereinafter referred to as training samples) trained after being processed by the multi-layer coding layers. For example, the probability of the training samples belonging to category A is 90%, and the probability of the training samples belonging to category B is 10%. During the training process, the feature vectors definitely have been through at least one distillation process, and the distillation loss value (distillation loss) can be obtained based on the distillation operation. When the distillation loss value is less than the certain fixed threshold value, the training is considered to be sufficient. Based on the obtained classification results, the classification accuracy rate is obtained based on the actual results.

In an example, when the model has been trained sufficiently, it is necessary to use a test set to verify whether the model has good performance, or whether it needs to be continually trained. The test set is a set composed of several test samples. The training set is used for training, and the training set is a set composed of training samples. For example, for image recognition tasks, the test set can have 5000 test samples (which can be considered as 5000 pictures), and the training set is a set composed of 10,000 training samples (10,000 pictures). The category to which certain training samples or test samples belong is determined based on the probability that the samples correspond to a certain category. Generally, the category corresponding to the maximum probability value is selected as the predicted category for the samples, and if the predicted category for a particular picture is the same as the category of the sample itself, then the sample prediction is correct. However, the classification accuracy rate is obtained by dividing the number of correctly predicted samples by the total number of samples. For example, for the classification accuracy rate of the test set, there are 4500 correctly predicted categories and a total number is 5000, the accuracy rate is 90% (4500/5000*100%).

In an example, it is possible to perform training several times with the same samples or different samples. For each training, a classification result can be obtained based on the final outputs at each training. At a later stage of multiple training, training is considered sufficient when the distillation loss values are all less than a certain threshold value, or when the distillation loss values become increasingly stable. At this time, the classification accuracy rate is obtained based on the classification results.

The above classification accuracy rate represents the final classification accuracy rate of the trained model, and when the classification accuracy rate reaches a preset target rate, it indicates that the model training is completed and the model is ready for use.

According to some embodiment of the disclosures, in the case that the classification accuracy rate does not reaches the preset target rate, the training is repeated continuously.

In an example, in the case that the first model has a plurality of coding layers and the classification accuracy rate does not reach the preset target rate, the outputs of any coding layer other than the first coding layer in the coding layers are selected as the inputs that are aggregated, and the training is continued. In detail, when the classification accuracy rate does not reach the preset target rate and the trained model includes a plurality of coding layers, the first coding layer can be re-selected in the model, but the newly-selected first coding layer may not be the previous first coding layer. In the solution of this example, the relevant coding layer for aggregating can be changed when the desired trained results may not be achieved by repeated training alone. For example, the previous dimensionality reduction in the second coding layer found that the pruning rate was too high, the classification accuracy rate in the training does not reach the expected rate, and the pruning positions can be adjusted, so that the pruning rate is reduced. That is, retraining is continued after replacing the first coding layer with a new layer, thereby improving the training efficiency.

Application Example:

Application of the processing flow of Example 1 of the disclosure includes the following content.

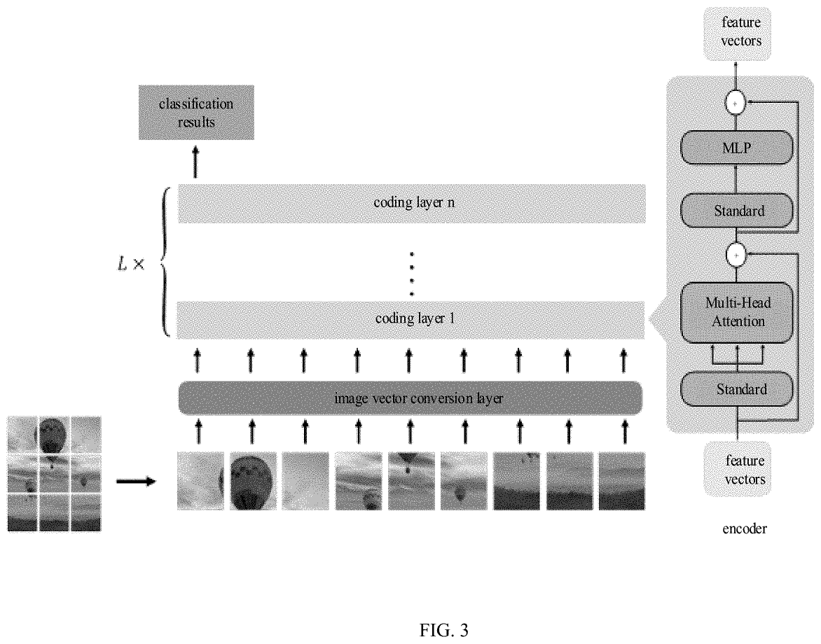

Before training, a trained model is obtained, which can be a Transformer model (also known as a vision transformer model or vision converter model) used in the CV field, as shown in FIG. 3. The model includes an image vector conversion layer (i.e., a linear projection or flattened patches layer) and multiple coding layers (i.e., transformer layers). The image vector conversion layer mainly performs linear transformation and/or pixel flattening arrangement on the input images, to convert each of the input images into a vector. Each coding layer consists of multiple encoders, and the encoder is composed of a standard module, a Multi-Head Attention module, a standard module, a Multilayer Perception (MLP, also called Multilayer Perceptron, generally composed of two layers) module. The number of encoders in each layer is determined by the number of input feature vectors. Each feature vector is input into an encoder, and a processed feature vector is output. The coding layer does not change the number of input feature vectors.

In an actual application scenario, the image is divided into patches of equal size, the size of each of the patches is equal, and each patch corresponds to an input position of the model. After passing through the image vector conversion layer, a number of feature vectors as equal to the number of the patches are generated. The feature vectors pass through multiple coding layers in turn, and one encoder in each coding layer processes one feature vector. The feature vectors output by the last coding layer are input into the classifier, and the classification results are obtained. The classification result may be a probability value, for example, the probability of recognizing that the input image is a dog is 90%, and the probability of recognizing that the input image is a cat is 10%.

The vision transformer model described above can process multiple input images simultaneously, which has a large amount of computation, occupies a lot of computing resources, and is time-consuming. In detail, equations (1) to (4) are formulas for deducing the calculation amount of an encoder in the model, in which equations (1) to (3) estimate the amount of calculations for each of the three main steps of the calculation process of the encoder, and equation (4) represents the calculation amount for the entire encoder. N represents the number of input patches or the number of input feature vectors, D represents the embedding size/embedding dim and is a product of the number of heads (also known as self-attention heads, individual self-attention computation heads) in the feature vectors during training and the dims (also known as the length of the feature vector) of each of the feature vectors. [N, D] represents matrices of dimension (N,D), [D, D] represents matrices of dimension (D,D), [N, D], [N, N] are similar and will not be repeated here.

4×([N,D]×[D,D])=>4ND² (1)

[N,D]×[D,N]+[N,N]×[N,D]=>2N²D (2)

[N,D]×[D,4D]+[N,4D]×[4D,D]=>8ND² (3)

12ND²+2N²D (4)

In the related art, if the model needs to be compressed, the methods mainly include two types. The first type is to reduce the number of layers of the new model (also called student model), i.e., if the trained model (also called teacher model) has N layers, the new model is configured to have M layers, where M<N, to reduce the amount of computation and achieve the compression effect. In the process of knowledge distillation, it is only necessary to choose one connection between the new model and the trained model, such as, spaced layer connection.

The second type is that the number of layers of the new model remains the same as the number of layers of the trained model, it is known based on the above equations that D needs to be compressed at this time. In detail, either head or dim is compressed.

Based on the above description, the two methods for model compressing basically start from the number of layers of the model and the embedding dim (also known as feature dim). The disclosure proposes another solution other than the above two methods, it can be seen from Equations (1) to (4) that the final amount of computation can also be reduced by dividing the image into less patches (the number of patches corresponds to the number of feature vectors in the training process, which can be represented by the number of sequences or tokens). That is, each layer of the student model is pruned and the feature vectors of each layer of the teacher model are ranked in the sequence dimension according to the values of the attention layers of the teacher model during training, and then the first N patches of the student model are aligned for knowledge distillation.

In the embodiment, the number of coding layers of the teacher model is identical to the number of coding layers of the student model, and the coding layers in two models have the same structure, i.e., each layer contains the same encoder. However, the initial parameters of the encoders of the corresponding layers are not necessarily the same and can be generated according to the actual application settings.

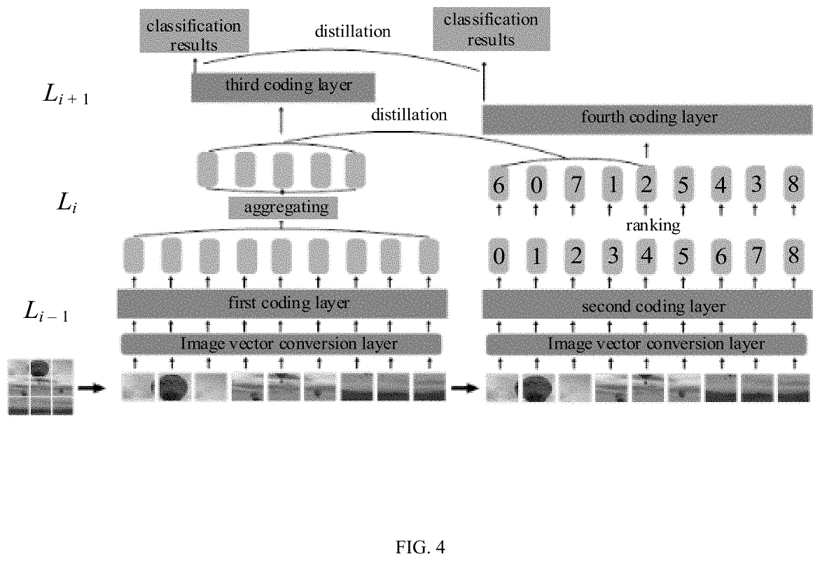

The specific distillation method is shown in FIG. 4, the student model is on the left and the trained teacher model is on the right. The training samples are N image patches, which will be converted into N feature vectors and input into the first coding layer that belongs to the student model and the second coding layer that belongs to the teacher model. After the first coding layer outputs N feature vectors, these N feature vectors are input into an aggregating layer to obtain the compressed M feature vectors, where M<N. After the second coding layer outputs N feature vectors, the N feature vectors are ranked according to the attention mechanism, and the M feature vectors that are ranked first are selected and subjected to distillation with the M feature vectors in the student model. The attention mechanism in the CV helps a model make more accurate judgments by assigning different weights to each part of the X inputs, and extracting more critical and important information. The essence of the attention mechanism is to use the relevant feature map to learn weight distribution, and then apply the learned weights to the original feature map to sum up the weights. The Softmax function (normalization function) is generally used in the multi-classification process, it maps the outputs of multiple neurons into the interval of (0,1), which can be understood as the interval of probabilities, to perform multi-classification. The above distillation is also known as aggregating distillation or pruning distillation.

In an example, the ranking can be performed based on the attention values of the cls token in the attention mechanism.

In an example, the teacher model uses the attention mechanism and the Softmax function to rank the feature vectors according to the importance through the following steps.

The weights of mutual attention value between any two feature vectors are calculated in each layer of the model. The weight can be calculated using a normalization (softmax) function or other functions for determining the attention values, to obtain the probability of the mutual attention value between any two feature vectors. The higher the probability the more important the feature vector is for classification. The ranking is performed according to the above probability values.

Moreover, there can be various distillation loss functions, taking Mean Squared Error (MSE) loss as an example, if the student model is reduced dimensionally, the number of token features in a certain layer is n, and for the teacher model, mutual attention probability for a certain layer of token features is obtained. After the ranking based on the above probability values is completed, the n token features ranked first are selected and subjected to MSE loss calculation with the n token features of the student model.

As illustrated in FIG. 4, for the student model, the input dimension of the L(i) layer model is [B, N, D], in which B is the batch size (number of samples in a batch), N is the number of feature vectors, and D is the embedding dim, [B, M, D] (M<N) is obtained using the convolution (conv1d) operation (or other aggregating operations). For the teacher model, the input dimension of the L(i) layer model is [B, N, D], and the value [B, H, N, N] after attention ranking is obtained by training, in which H is the number of heads in the multi-head-attention module, D=H*d, and d is the size of a single head. Since the value of attention is the result after softmax, the softmax result is the feature vector importance probability, the feature vectors of the teacher model are ranked according to this probability value, and the M feature vectors that are ranked first are selected for distillation, so that the pruning distillation process of model training is achieved.

It can be seen that the model distillation method is introduced in the above-mentioned embodiments, that is, the outputs of a certain layer in the student model are aggregated, the outputs of the corresponding layer in the teacher model are also ranked, and then the corresponding feature vectors are distilled. The aggregating of the feature vectors is also called pruning. Since the number of encoders in each layer is determined by the number of input feature vectors, the encoders in each layer will be reduced correspondingly after the feature vectors are reduced, so that the effect of compressing the student model is achieved.

In addition, there is another distillation method, which can be called direct distillation. As shown in FIG. 4, after at least one aggregation process is completed, the outputs of the coding layer can also be directly distilled. At this time, there are still M feature vectors output by the third coding layer in the student model, and M feature vectors are selected from the fourth coding layer of the teacher model to be distilled with the student model. The selection process is the same as the previous distillation method, which is not repeated here.

Based on the outputs of the last coding layer, the classification results are obtained, and the classification accuracy rate (also called classification indicator) can be obtained based on the classification results. For the classification indicator, if there are 1000 images of different categories in the test set, and the model put the images into categories, and if the categories of 800 images are judged correctly, then the classification indicator is 80%. When the target test set data is trained sufficiently, the classification indicator will tend to be stable and stop rising, at this time, generally, the distillation loss value will also be stable. Therefore, the training of the model can be considered as being completed when the classification indicator or the distillation loss value is stabilized.

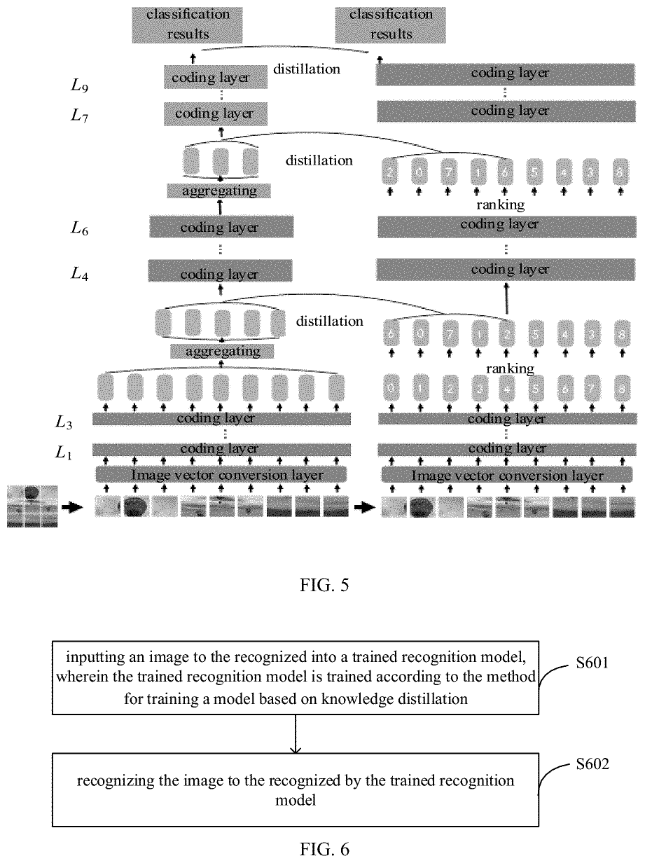

It should be emphasized that both of these distillations can be used in any layer of the model and can be reused for multiple times. The reuse of distillation in the student model is referred to FIG. 5. In FIG. 5, it can be seen that the teacher model and the student model both have 9 coding layers (L₁ to L₉), and pruning distillation is applied in L₄, L₅, L₇ and L₈, and direct distillation is applied in L₉.

In addition, the model to be pruned and compressed is generally fixed, that is, the number of layers of the student model is determined before training. If the accuracy rate still cannot reach the preset target rate after repeating the training for many times, the area where the dimensionality reduction and distillation is performed, i.e., the aggregating area, is adjusted generally. For example, as mentioned previously, dimensionality reduction is performed in L₂, it is found that the pruning rate was too high, resulting in the training accuracy rate cannot reach the expected rate, thus the pruning position is adjusted to reduce the pruning rate.

As illustrated in FIG. 6, the embodiment of the disclosure provides a method for recognizing an image. The method includes the following steps.

At block S601, an image to be recognized is input into a trained recognition model, the trained recognition model is trained according to the above method for training a model based on knowledge distillation.

At block S602, the image to be recognized is recognized by the trained recognition model.

In an example, “the method for training a model based on knowledge distillation” refers to the above training method described above in the disclosure, which will not be repeated. The image to be recognized is input into a recognition model. In detail, before inputting the image to be recognized into the recognition model, it is necessary to process the image to be recognized according to the specific requirements of the model. For example, after dividing the image to be recognized into multiple patches, the patches are input into the model in parallel. The trained recognition model is a compressed model, and the model has the advantages of small amount of computation and small occupied resource space, and the capability of being flexibly deployed on the devices with limited computing capability.

It should be emphasized that the execution subject of the method for recognizing an image and the above-mentioned training method may be the same subject or different subjects. That is, the model can be trained on the same device, and then the recognition method can be implemented by using the trained model on the same device, or the training and application of the model can be performed on different devices respectively.

In an example, the method for recognizing an image can also be used in scenes such as image object detection and image segmentation. The image object detection is to obtain the specific position of the object on the basis of identifying the type of object in the image. The image segmentation is to accurately identify the object's edges on the basis of obtaining the identified object type and position, and further divide the image along the edges. In conclusion, the method for recognizing an image can also be used in various application scenarios based on image recognition, which is not limited here.

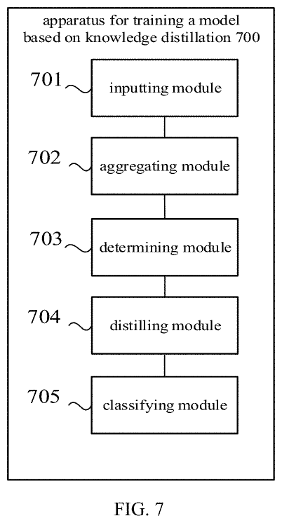

As illustrated in FIG. 7, the embodiment of the disclosure provides an apparatus 700 for training a model based on knowledge distillation. The apparatus includes: an inputting module 701, an aggregating module 702, a determining module 703, a distilling module 704 and a classifying module 705.

The inputting module 701 is configured to input feature vectors obtained based on trained sample images into a first coding layer and a second coding layer, in which the first coding layer belongs to a first model, and the second coding layer belongs to a second model.

The aggregating module 702 is configured to obtain first feature vectors by aggregating output results of the first coding layer.

The determining module 703 is configured to determine second feature vectors based on outputs of the second coding layer.

The distilling module 704 is configured to update the first feature vectors by performing a distillation on the first feature vectors and the second feature vectors.

The classifying module 705 is configured to complete training of the first model by classifying the first feature vectors that are updated.

As illustrated in FIG. 8, the classifying module 705 includes: a first input unit 801, a second input unit 802, a distilling unit 803 and a classifying unit 804.

The first input unit 801 is configured to input the first feature vectors that are updated into a third coding layer, in which the third coding layer belongs to the first model.

The second input unit 802 is configured to input the second feature vectors that are updated after the distillation into a fourth coding layer, in which the fourth coding layer belongs to the second model.

The distilling unit 803 is configured to obtain optimized results by performing another distillation on output results of the third coding layer and the fourth coding layer.

The classifying unit 804 is configured to complete the training of the first model by classifying the optimized results.

In an example, the distilling module is further configured to: perform the distillation on the first feature vectors and feature vectors that are ranked first in the second feature vectors, in which a number of the first feature vectors is the same as a number of the feature vectors that are ranked first in the second feature vectors.

In an example, the apparatus further includes: a classification result obtaining module and a classification accuracy rate obtaining module.

The classification result obtaining module is configured to obtain classification results based on feature vectors output by the last coding layer of the first model.

The classification accuracy rate obtaining module is configured to, in response to a distillation loss value in the distillation being less than a fixed threshold value, obtain a classification accuracy rate based on the classification results.

In an example, the apparatus further includes: a reselecting module, configured to, in response to that the first model has a plurality of coding layers and the classification accuracy rate does not satisfy a preset target rate, determine outputs of any one of the plurality of coding layers other than the first coding layer as inputs of the aggregating to continue training the first model.

In an example, the aggregating module is further configured to: perform convolution process on the output results of the first coding layer.

In an example, the inputting module is further configured to: convert a plurality of pictures of equal size into a plurality of feature vectors of the same dimensions, in which a number of the pictures is equal to a number of the generated feature vectors; and input the plurality of feature vectors into the first coding layer and the second coding layer in parallel.

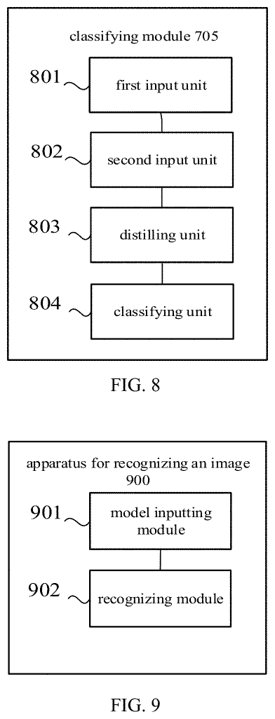

As illustrated in FIG. 9, the embodiment of the disclosure provides an apparatus for recognizing an image 900. The apparatus includes: a model inputting module 901 and a recognizing module 902,

The model inputting module 901 is configured to input an image to be recognized into a trained recognition model, in which the trained recognition model is obtained according to the above apparatus for training a model based on knowledge distillation of any one of the embodiments.

The recognizing module 902 is configured to recognize the image to be recognized by the trained recognition model.

For the functions of the modules in the embodiments of the disclosure, reference may be made to the corresponding descriptions in the above methods, and details are not described herein again.

In the technical solution of the disclosure, acquisition, storage, and application of the user's personal information involved all comply with the provisions of relevant laws and regulations, and do not violate public order and good customs.

According to embodiments of the disclosure, the disclosure provides an electronic device, and a readable storage medium, and a computer program product.

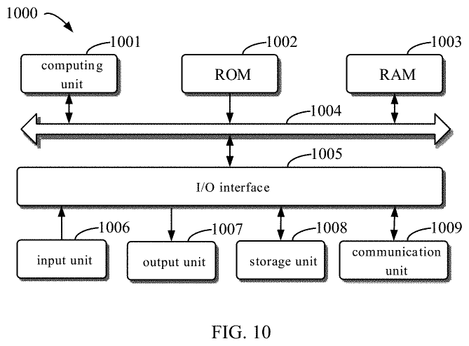

FIG. 10 is a block diagram of an example electronic device 1000 used to implement the embodiments of the disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the disclosure described and/or required herein.

As illustrated in FIG. 10, the electronic device 1000 includes: a computing unit 1001 performing various appropriate actions and processes based on computer programs stored in a read-only memory (ROM) 1002 or computer programs loaded from the storage unit 1008 to a random access memory (RAM) 1003. In the RAM 1003, various programs and data required for the operation of the device 1000 are stored. The computing unit 1001, the ROM 1002, and the RAM 1003 are connected to each other through a bus 1004. An input/output (I/O) interface 1005 is also connected to the bus 1004.

Components in the device 1000 are connected to the I/O interface 1005, including: an inputting unit 1006, such as a keyboard, a mouse; an outputting unit 1007, such as various types of displays, speakers; a storage unit 1008, such as a disk, an optical disk; and a communication unit 1009, such as network cards, modems, and wireless communication transceivers. The communication unit 1009 allows the device 1000 to exchange information/data with other devices through a computer network such as the Internet and/or various telecommunication networks.

The computing unit 1001 may be various general-purpose and/or dedicated processing components with processing and computing capabilities. Some examples of computing unit 1001 include, but are not limited to, a CPU, a graphics processing unit (GPU), various dedicated AI computing chips, various computing units that run machine learning model algorithms, and a digital signal processor (DSP), and any appropriate processor, controller and microcontroller. The computing unit 1001 executes the various methods and processes described above, such as the method for training a model based on knowledge distillation, or the method for recognizing an image. For example, in some embodiments, the above method may be implemented as a computer software program, which is tangibly contained in a machine-readable medium, such as the storage unit 1008. In some embodiments, part or all of the computer program may be loaded and/or installed on the device 1000 via the ROM 1002 and/or the communication unit 1009. When the computer program is loaded on the RAM 1003 and executed by the computing unit 1001, one or more steps of the method described above may be executed. Alternatively, in other embodiments, the computing unit 1001 may be configured to perform the method in any other suitable manner (for example, by means of firmware).

Various implementations of the systems and techniques described above may be implemented by a digital electronic circuit system, an integrated circuit system, Field Programmable Gate Arrays (FPGAs), Application Specific Integrated Circuits (ASICs), Application Specific Standard Products (ASSPs), System on Chip (SOCs), Load programmable logic devices (CPLDs), computer hardware, firmware, software, and/or a combination thereof. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method of the disclosure may be written in any combination of one or more programming languages. These program codes may be provided to the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in combination with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage medium include electrical connections based on one or more wires, portable computer disks, hard disks, random access memories (RAM), read-only memories (ROM), electrically programmable read-only-memory (EPROM), flash memory, fiber optics, compact disc read-only memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: local area network (LAN), wide area network (WAN), and the Internet.

The computer system may include a client and a server. The client and server are generally remote from each other and interacting through a communication network. The client-server relation is generated by computer programs running on the respective computers and having a client-server relation with each other. The server may be a cloud server, a server of a distributed system, or a server combined with a block-chain.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of this application shall be included in the protection scope of this application.

What is claimed is:

1. A method for training a model based on knowledge distillation, comprising:
inputting feature vectors obtained based on trained sample images into a first coding layer and a second coding layer, wherein the first coding layer belongs to a first model, and the second coding layer belongs to a second model;
obtaining first feature vectors by aggregating output results of the first coding layer;
determining second feature vectors based on outputs of the second coding layer;
updating the first feature vectors by performing a distillation on the first feature vectors and the second feature vectors; and
completing training of the first model by classifying the first feature vectors that are updated.

2. The method of claim 1, wherein completing the training of the first model by classifying the first feature vectors that are updated, comprises:
inputting the first feature vectors that are updated into a third coding layer, wherein the third coding layer belongs to the first model;
inputting the second feature vectors that are updated after the distillation into a fourth coding layer, wherein the fourth coding layer belongs to the second model;
obtaining optimized results by performing another distillation on output results of the third coding layer and the fourth coding layer; and
completing the training of the first model by classifying the optimized results.

3. The method of claim 1, wherein performing the distillation on the first feature vectors and the second feature vectors, comprises:
performing the distillation on the first feature vectors and feature vectors that are ranked first in the second feature vectors, wherein a number of the first feature vectors is the same as a number of the feature vectors that are ranked first in the second feature vectors.

4. The method of claim 1, further comprising:
in response to a distillation loss value in the distillation being less than a fixed threshold value, obtaining a classification accuracy rate based on classification results.

5. The method of claim 4, further comprising:
in response to that the first model has a plurality of coding layers and the classification accuracy rate does not satisfy a preset target rate, determining outputs of any one of the plurality of coding layers other than the first coding layer as inputs of the aggregating to continue training the first model.

6. The method of claim 1, wherein aggregating the output results of the first coding layer, comprises:
performing convolution process on the output results of the first coding layer.

7. The method of claim 1, wherein inputting the feature vectors obtained based on the trained sample images into the first coding layer and the second coding layer, comprises:
converting a plurality of pictures of equal size into a plurality of feature vectors of the same dimensions, wherein a number of the plurality of pictures is equal to a number of the plurality of feature vectors; and
inputting the plurality of feature vectors into the first coding layer and the second coding layer in parallel.

8. The method of claim 1, further comprising:
inputting an image to be recognized into the trained model; and
recognizing the image to be recognized by the trained model.

9. An electronic device, comprising:
a processor; and
a memory communicatively coupled to the processor;
wherein the memory is configured to store instructions executable by the processor, and the processor is configured to execute the instructions to:
input feature vectors obtained based on trained sample images into a first coding layer and a second coding layer, wherein the first coding layer belongs to a first model, and the second coding layer belongs to a second model;
obtain first feature vectors by aggregating output results of the first coding layer;
determine second feature vectors based on outputs of the second coding layer;
update the first feature vectors by performing a distillation on the first feature vectors and the second feature vectors; and
complete training of the first model by classifying the first feature vectors that are updated.

10. The device of claim 9, wherein the processor is configured to execute the instructions to:
input the first feature vectors that are updated into a third coding layer, wherein the third coding layer belongs to the first model;
input the second feature vectors that are updated after the distillation into a fourth coding layer, wherein the fourth coding layer belongs to the second model;
obtain optimized results by performing another distillation on output results of the third coding layer and the fourth coding layer; and
complete the training of the first model by classifying the optimized results.

11. The device of claim 9, wherein the processor is configured to execute the instructions to:
perform the distillation on the first feature vectors and feature vectors that are ranked first in the second feature vectors, wherein a number of the first feature vectors is the same as a number of the feature vectors that are ranked first in the second feature vectors.

12. The device of claim 9, wherein the processor is configured to execute the instructions to:
in response to a distillation loss value in the distillation being less than a fixed threshold value, obtain a classification accuracy rate based on classification results.

13. The device of claim 12, wherein the processor is configured to execute the instructions to:
in response to that the first model has a plurality of coding layers and the classification accuracy rate does not satisfy a preset target rate, determines outputs of any one of the plurality of coding layers other than the first coding layer as inputs of the aggregating to continue training the first model.

14. The device of claim 9, wherein the processor is configured to execute the instructions to:
perform convolution process on the output results of the first coding layer.

15. The device of claim 9, wherein the processor is configured to execute the instructions to:
convert a plurality of pictures of equal size into a plurality of feature vectors of the same dimensions, wherein a number of the plurality of pictures is equal to a number of the plurality of feature vectors; and
input the plurality of feature vectors into the first coding layer and the second coding layer in parallel.

16. The device of claim 9, wherein the processor is configured to execute the instructions to:
input an image to be recognized into the trained model; and
recognizing the image to be recognized by the trained model.

17. A non-transitory computer-readable storage medium having computer instructions stored thereon, wherein the computer instructions are configured to cause a computer to implement a method for training a model based on knowledge distillation, the method comprising:
inputting feature vectors obtained based on trained sample images into a first coding layer and a second coding layer, wherein the first coding layer belongs to a first model, and the second coding layer belongs to a second model;
obtaining first feature vectors by aggregating output results of the first coding layer;
determining second feature vectors based on outputs of the second coding layer;
updating the first feature vectors by performing a distillation on the first feature vectors and the second feature vectors; and
completing training of the first model by classifying the first feature vectors that are updated.

18. The non-transitory computer-readable storage medium of claim 17, wherein completing the training of the first model by classifying the first feature vectors that are updated, comprises:
inputting the first feature vectors that are updated into a third coding layer, wherein the third coding layer belongs to the first model;
inputting the second feature vectors that are updated after the distillation into a fourth coding layer, wherein the fourth coding layer belongs to the second model;
obtaining optimized results by performing another distillation on output results of the third coding layer and the fourth coding layer; and
completing the training of the first model by classifying the optimized results.

19. The non-transitory computer-readable storage medium of claim 17, wherein performing the distillation on the first feature vectors and the second feature vectors, comprises:
performing the distillation on the first feature vectors and feature vectors that are ranked first in the second feature vectors, wherein a number of the first feature vectors is the same as a number of the feature vectors that are ranked first in the second feature vectors.

20. The non-transitory computer-readable storage medium of claim 17, wherein the method further comprises:
in response to a distillation loss value in the distillation being less than a fixed threshold value, obtaining a classification accuracy rate based on classification results.
